(19) United States
(12) Patent Application Publication
(10) Pub. No.: US 2010/0002968 A1
(43) Pub. Date: Jan. 7, 2010

(54) Plain Bearing

(75) Inventor: Robert Mergen, Altmunster (AT)

Correspondence Address: COLLARD & ROE, P.C., 1077 NORTHERN BOULEVARD, ROSLYN, NY, 11576, US

(73) Assignee: MIBA GLEITLAGER GMBH, Laakirchen (AT)

(21) Appl. No.: 12/310,290

(22) PCT Filed: Aug. 28, 2007
(86) PCT No.: PCT/AT2007/000410

§ 371 Date: Feb. 19, 2009

(30) Foreign Application Priority Data
Sep. 1, 2006 (AT) A 1456/2006

(51) Int. Cl. F16C 17/00

(52) U.S. Cl. 384/129

(57) ABSTRACT

A plain bearing is described, comprising a steel support shell and a lead-free bearing metal layer on the basis of copper with the main alloy elements of tin and zinc applied to the support shell. In order to achieve advantageous bearing properties it is proposed that the bearing metal layer has a tin fraction of 2.5 to 11 percent by weight, a zinc fraction of 0.5 to 5 percent by weight, a fraction of zirconium and titanium together of at least 0.01 percent by weight and a fraction of phosphorus of at least 0.03 percent by weight, with the sum total of the fractions of zirconium, titanium and phosphorus being at most 0.25 percent by weight and the sum total of the fractions of tin and zinc being between 3 and 13 percent by weight.

### FIELD OF THE INVENTION

The invention relates to a plain bearing with a steel support shell and a lead-free bearing metal layer on the basis of copper with the main alloy elements of tin and zinc applied to the support shell.

### DESCRIPTION OF THE PRIOR ART

Plain bearing materials on the basis of copper with tin and zinc as the main alloy elements have been known for a long time, but a comparatively high fraction of lead had to be added to the alloy for these bearing materials for use in hydrodynamic bearings for the drive train of internal combustion engines for improving the tribological properties. However, bearings with these known plain bearing materials could only meet the requirements when the bearing metal layer applied to a steel support shell was covered with a running layer which had special slide properties because the high content in lead ensured sufficient security against the seizing tendency, but did not offer the required sliding capability.

The toxicity of lead bronzes is increasingly preventing the use of such bearing materials. The attempt to replace lead bronzes by lead-free plain bearing materials on the basis of copper with tin and zinc as the main alloy elements was always accompanied by an impaired tribological suitability of the substitute bearing materials. It was proposed for example (DE 103 08 779 B3) to improve the sliding properties of a brass alloy which comprises at least 21.3 percent by weight of zinc and at most 3.5 percent by weight of tin by the addition of magnesium, iron or cobalt, nickel and manganese or silicon, but without any resounding success however. Similarly insufficient sliding properties are obtained in another known lead-free copper alloy with at least 8.5 percent by weight of zinc and 1 to 5 percent by weight of silicon as the main alloy components (DE 103 08 778 B3) and with at most 2 percent by weight of tin and slight fractions of iron or cobalt, nickel and manganese. If the addition of lead is avoided by adding bismuth in a magnitude of 0.5 to 2 percent by weight (EP 0 457 478 B1) to a copper alloy with a tin content of 6 percent by weight for example, it is possible to improve the tribological properties, but at the same time the mechanical strength characteristics will decrease, which makes these bearing materials unsuitable for use in bearings for the drive train of high-performance internal combustion engines. To this date, only bearing materials on the basis of bronzes with a high content of lead could fulfill these bearing requirements. The increasing ignition pressures of modern combustion engines show however that even such lead bronzes will soon meet their mechanical load limits due to their share in lead. An additional factor is that a sufficient corrosion resistance against aggressive lubricants is ensured and favorable cold-forming capability needs to be considered, so that even lead bronzes are no longer able to meet the requirements on the load-bearing capacity of the bearing materials.

### SUMMARY OF THE INVENTION

The invention is thus based on the object of providing a plain bearing of the kind mentioned above with a lead-free bearing metal layer on the basis of copper which offers favorable corrosion resistance, high strength in combination with high tenacity and improved behavior against contamination with lubricants and seizing.

This object is achieved by the invention in such a way that the bearing metal layer has a fraction of tin of 2.5 to 11 percent by weight, a fraction of zinc of 0.5 to 5 percent by weight, a fraction of zirconium and titanium together of at least 0.01 percent by weight and a fraction of phosphorus of at least 0.03 percent by weight, with the sum total of the fractions of zirconium, titanium and phosphorus being at most 0.25 percent by weight and the sum total of the fractions of tin and zinc being between 3 and 13 percent by weight.

It was surprisingly noticed that as a result of the proposed composition it was possible to improve the tendency to seizing of the bearing metal layer to a decisive extent. It is assumed that the lower tendency to seizing is caused by a matrix consisting predominantly of alpha bronze and the presence of alpha/delta eutectoids which are distributed in an ultra-fine manner at the grain boundary, with titanium and zirconium having a relevant influence on the fineness of the alpha/delta eutectoids, but only when the elements of titanium and zirconium are protected from premature oxidation by the addition of phosphorus. A distinct improvement of the seizing behavior of the bearing metal layer can already be achieved at a fraction of zirconium and titanium of 0.01 percent by weight together. Precondition for this is a respective protection from oxidation which requires a minimum fraction of phosphorus of 0.03 percent by weight. When fractions of zirconium and titanium are chosen that are too high, these elements have an embrittling effect on the matrix, thus unacceptably limiting the deformability of the bearing metal layer. Excessive fractions of phosphorus must also be avoided in order to avoid endangering ductility and fatigue strength of the bearing material. In the case of a sum total of the fractions of zirconium, titanium and phosphorus of not more than 0.25 percent, a ductility that meets the requirements can be ensured. The fraction of phosphorus can advantageously be limited upwardly with 0.08 percent by weight.

With the indicated fraction ranges of tin and zinc, the requirements based on the sliding properties of the bearing metal layer and the mechanical strength of the bearing can be fulfilled in a favorable way. When limiting the fraction of tin to 11 percent by weight at most, unacceptable hardening effects will not yet occur. Moreover, phase compositions that would lead to embrittlement are not to be expected yet. Zinc represents a suitable substitute for higher phosphorus fractions used otherwise which could have a negative effect on the bond of the bearing metal layer with the steel support shell as a result of the formation of intermetallic iron/phosphorus compounds. The alloy of the bearing metal layer can be managed well in respect to casting and sintering technique, so that they are advantageously suitable for cast and sinter coating on steel.

The addition of zinc also improves the protection from oxidation in the liquid phase of the alloy production and supports the formation of the tribologically advantageous alpha/delta eutectoids. In order to utilize the advantages of zinc in the bearing metal layer, a minimum content of 0.5 percent by weight is required. The fraction of zinc must not exceed 5 percent by weight however, so that corrosion resistance is not impaired.

Due to the known effects of nickel, manganese, aluminum, silver, iron, arsenic, antimony, magnesium and cobalt on the strength, thermal strength and corrosion resistance, the bearing metal layer can comprise at least one of these elements, whereby the individual fraction of these elements should be not more than 2.5 percent by weight and the summary fraction of the employed elements of this group should not be more than 11 percent by weight, preferably not more than 9.5 percent by weight, because otherwise the required properties of the bearing metal layer cannot be achieved. Notice must be taken in this context that the solubility of these elements must not be obstructed by an excessive fraction of zinc for example in order to avoid impairing the formation of the matrix in the form of an alpha bronze. Especially advantageous conditions are generally obtained when the individual fraction of the employed elements of the element group is not more than 0.5 percent by weight, preferably not more than 0.05 percent by weight.

In order to further reduce the seizing tendency, the bearing metal layer can comprise a bismuth fraction of not more than 2 percent by weight. In the case of a bismuth fraction beneath 2 percent by weight, the required strength values can be maintained. Higher shares of bismuth will lead to a weakening of the matrix however. The lower corrosion resistance caused by bismuth will then also lead to the consequence that corrosion attacks can become effective in deeper lying matrix regions.

### DESCRIPTION OF THE PREFERRED EMBODIMENTS

In order to determine the seizing resistance, a test bearing with a diameter of 48.0 mm, a width of 21.00 mm and a bearing play of 1.4 ‰ was subjected to a static load at a speed of 5000 rpm and an oil rate of 1.1 L/min at a pressure of 0.7 bar and an oil feed temperature of 120° C., which load was increased every 1.75 mins in steps until seizing and the attrition load was measured. Whereas in known lead-free bearing metal alloys on the basis of copper with tin as the main alloy element at most one of the required minimum values for the average seizing resistance of 20 MPa for the attrition load for example and fatigue strength of 150 MPa for example at 2.10⁶ is achieved, these minimum values can be ensured with the plain bearings in accordance with the invention easily. It was managed to measure an attrition load of 24 MPa and a bend fatigue strength of 152 MPa in bearing metal alloys on copper basis with 3 percent by weight of tin, 1 percent by weight of zinc and a summary fraction of zirconium, titanium and phosphorus of 0.08 percent by weight at a nickel fraction of 1 percent by weight and an aluminum fraction of 0.3 percent by weight. When the tin fraction was increased to 4 percent by weight and the summary fraction of zirconium, titanium and phosphorus was increased to 0.09 percent by weight, the attrition load was 24 MPa and the bend fatigue strength 154 MPa without adding nickel and aluminum to the alloy. In the case of an additional increase of the summary fraction of zirconium, titanium and phosphorus to 0.12 percent by weight and an addition to the alloy of 0.05 percent by weight of cobalt and 0.05 percent by weight of magnesium, it was possible to increase the attrition load to 28 MPa and the bend fatigue strength to 164 MPa. In the case of a bearing metal layer on copper basis with 4 percent by weight of tin, 1 percent by weight of zinc and a summary fraction of zirconium, titanium and phosphorus of 0.11 percent by weight, an attrition load of 26 MPa and a bend fatigue strength of 163 MPa were determined on application onto the steel support shell by roll-bonding. With the same bearing metal alloy that was cast however, it was possible to achieve a friction load of 24 MPa and a bend fatigue strength of 156 MPa. With an additional increase of the share of tin, the values for the attrition load and the bend fatigue strength will also increase. An attrition load of 34 MPa and a bend fatigue strength of 168 MPa were achieved with a tin fraction of 5 percent by weight and an unchanged zinc fraction of 1 percent by weight and a summary fraction of zirconium, titanium and phosphorus of 0.01 percent by weight with an additional fraction of iron of 0.2 percent by weight and manganese of 0.1 percent by weight. Without these additional elements of iron and manganese, the attrition load was 35 MPa and the bend fatigue strength was 163 MPa. A further increase in the tin fraction to 8 percent by weight and the summary fraction of zirconium, titanium and phosphorus to 0.17 percent by weight led to an attrition load of 37 MPa and a bend fatigue strength of 173 MPa with an unchanged zinc fraction and an additional fraction of 0.02 percent by weight of manganese, 0.1 percent by weight of cobalt and 1 percent by weight of nickel.

1: A plain bearing with a steel support shell and a lead-free bearing metal layer on the basis of copper with the main alloy elements of tin and zinc applied to the support shell, wherein the bearing metal layer has a tin fraction of 2.5 to 11 percent by weight, a zinc fraction of 0.5 to 5 percent by weight, a fraction of zirconium and titanium together of at least 0.01 percent by weight and a fraction of phosphorus of at least 0.03 percent by weight, with the sum total of the fractions of zirconium, titanium and phosphorus being at most 0.25 percent by weight and the sum total of the fractions of tin and zinc being between 3 and 13 percent by weight.

2: A plain bearing according to claim 1, wherein the phosphorus fraction is upwardly limited with 0.08 percent by weight.

3: A plain bearing according to claim 1, wherein the bearing metal layer comprises at least one additional element from the element group comprising nickel, manganese, aluminum, silver, iron, arsenic, antimony, magnesium and cobalt, with the individual fraction of these elements being at most 2.5 percent by weight and the summary fraction of the employed elements of this group being at most 11 percent by weight, preferably not more than 9.5 percent by weight.

4: A plain bearing according to claim 3, wherein the individual fraction of the employed elements of the element group is not more than 0.5 percent by weight, preferably not more than 0.05 percent by weight.

5: A plain bearing according to claim 1, wherein the bearing metal layer has a bismuth fraction of not more than 2 percent by weight.
